(19) United States
(12) Patent Application Publication
(10) Pub. No.: US 2025/0103365 A1
(43) Pub. Date: Mar. 27, 2025

(54) INTELLIGENTLY DETECTING RESOURCE SCHEDULES IN A COMPUTING ENVIRONMENT

(71) Applicant: International Business Machines Corporation, Armonk, NY (US)

(72) Inventors: Ming Xia Guo, Beijing (CN); Bo Chen Zhu, Xi'an (CN); Yong Quan Tian, Beijing (CN); Mai Zeng, Beijing (CN); Meng Jie Min, Beijing (CN); Yan An, Shanghai (CN); Min Cheng, Beijing (CN)

(21) Appl. No.: 18/371,335

(22) Filed: Sep. 21, 2023

(51) Int. Cl. G06F 9/455

(52) U.S. Cl. CPC G06F 9/45558; G06F 2009/45562; G06F 2009/4557

(57) ABSTRACT

In several aspects for detecting a computing system resource schedule, a computing device performs a pre-analysis process utilizing a collected log from multiple sources. The pre-analysis process including a data formatter that identifies data based on a metric, and a dimensionality reduction process that distributes the data into an n-dimensional space. Key patterns are extracted to separate a normal status and an abnormal status for the extracted key patterns. A post-analysis process is performed on the extracted key patterns utilizing a threshold formatter to identify a threshold for a health check.

### BACKGROUND

The present invention relates generally to the field of virtual machine instance (VMI) scheduling, and more particularly to intelligently detecting resource schedules for computing systems.

In most cloud environments, the VMI is scheduled on a node, but often the VMI is in a pending status due to the virtual network interface card (VNIC), virtual disk (vdisk), volume or a multi-distribution method for cross-platform cloud instance initialization (e.g., cloud-init) on that node is not ready, cannot become into running status. Root causes include controller pods crashed, process services crashed, network issues, storage outage, etc. Need the site reliability engineering (SRE), etc., to check the cloud-based log management system that aggregates the system and application logs into a single location or login in the environment to debug and fix the pending problem. It is currently difficult to quickly and timely judge whether a node is stable, whether a VMI can be successfully created, and if the creation fails, it is impossible to quickly locate the cause of the error. The main reasons for this situation are complexity of the log, complexity of root causes and lag in trouble shooting.

### SUMMARY

Embodiments relate to intelligently detecting resource schedules for computing systems (e.g., cloud-based computing systems, etc.). One embodiment provides a method including performing, by a computing device, a pre-analysis process utilizing a collected log from multiple sources. The pre-analysis process including a data formatter that identifies data based on a metric, and a dimensionality reduction process that distributes the data into an n-dimensional space. Key patterns are extracted to separate a normal status and an abnormal status for the extracted key patterns. A post-analysis process is performed on the extracted key patterns utilizing a threshold formatter to identify a threshold for a health check.

A computer system and a computer program product configured to perform the above-described method are also disclosed herein.

These and other features, aspects and advantages of the present embodiments will become understood with reference to the following description, appended claims and accompanying figures.

### BRIEF DESCRIPTION OF THE DRAWINGS

FIG. 1 illustrates a system architecture intelligently detecting resource schedules for computing systems, according to some embodiments;

FIG. 2 illustrates a representation of formatting for each history log, according to some embodiments;

FIG. 3 illustrates a graph of Log T-D dimension distribution, according to some embodiments;

FIG. 4 illustrates a flow diagram for a health checker, according to some embodiments;

FIG. 5 illustrates a process for intelligently detecting resource schedules for computing systems, according to some embodiments; and

FIG. 6 illustrates an example computing environment utilized by some embodiments.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to intelligently detecting resource schedules for computing systems (e.g., cloud-based computing systems, etc.). One embodiment provides a method including performing, by a computing device, a pre-analysis process utilizing a collected log from multiple sources. The pre-analysis process including a data formatter that identifies data based on a metric, and a dimensionality reduction process that distributes the data into an n-dimensional space. Key patterns are extracted, by the computing device, to separate a normal status and an abnormal status for the extracted key patterns. A post-analysis process is performed, by the computing device, on the extracted key patterns utilizing a threshold formatter to identify a threshold for a health check. A computer system and a computer program product configured to perform the above-described method are also disclosed herein.

One or more embodiments significantly improve solving the problems that lead to the failure of VMI creation in a timely manner using multiple health check processes. Some embodiments provide collection of scattered data, extraction of key patterns via data formatting and data dimensionality reduction processing. Extracted patterns are used to separate the normal and abnormal status during VMI creation. The patterns are used as the input into a threshold formatter to identify the threshold for health check processes. With the health check processes, some embodiments improve the possibility to discover an exception in the VMI creation process and to predict whether the VMI can be successfully created in advance.

One or more of the following features may be included. Some embodiments may include the feature that the health check is utilized for discovering an exception in a VMI creation process.

One or more embodiments may further include the feature that the health check is utilized to predict whether a VMI can be successfully created in advance.

In some embodiments, a runtime log is provided as input to a failed pattern filter that determines whether the runtime log passes the failed pattern filter.

One or more embodiments may additionally include the feature of upon the runtime pattern filter passing the runtime log, a timer reset check determines whether a next normal pattern is reached based on a threshold.

One or more embodiments may further include the feature of a health check agent that is generated for a plurality of system components for the pre-analysis process and the post-analysis process.

Some embodiments may additionally include the feature that the health check is applied to a runtime log in each of the multiple sources.

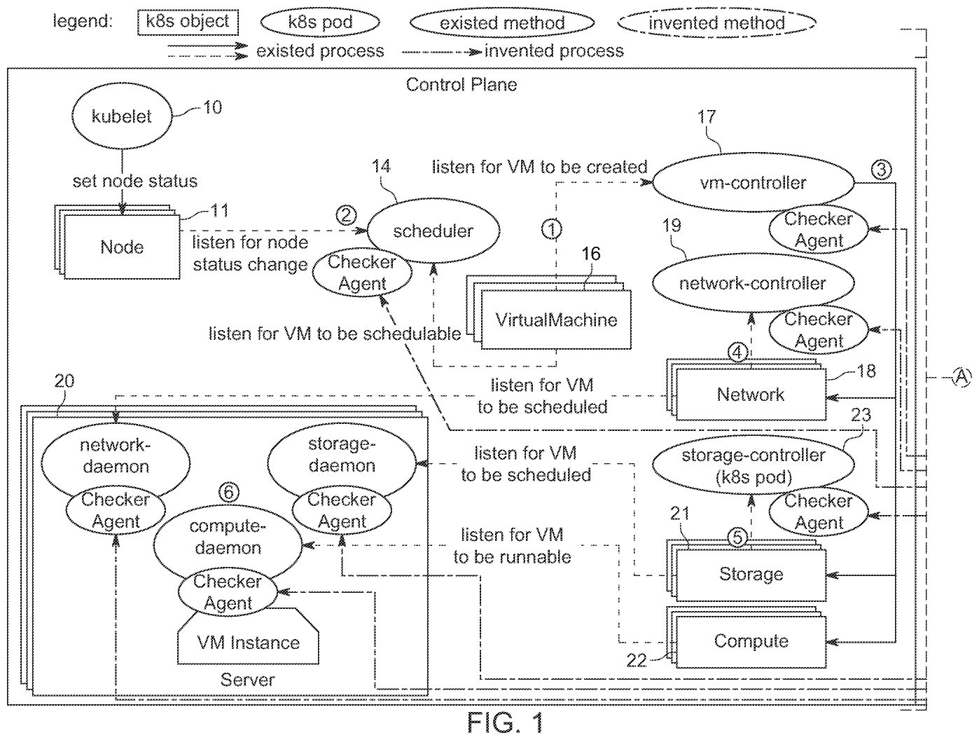

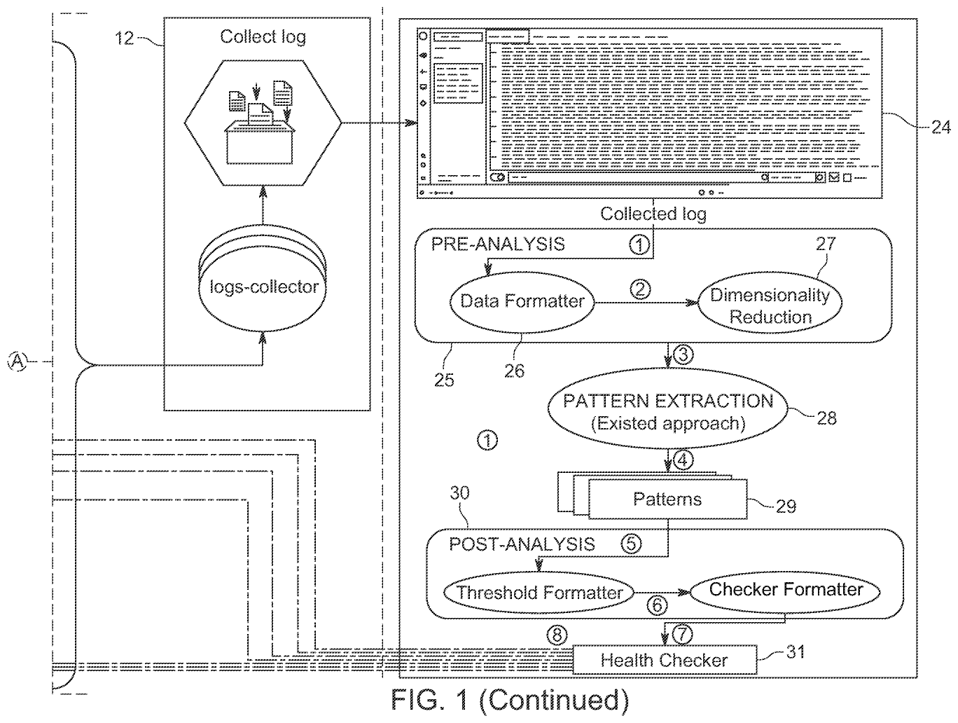

FIG. 1 illustrates a system architecture intelligently detecting resource schedules for computing systems, according to some embodiments. In one or more embodiments, there are many pods for different processes and purposes. Pods are the smallest deployable units of computing that you can create and manage in KUBERNETES® (k8s), which is an open-source container orchestration system for automating software deployment, scaling, and management. Each pod produces a log, and history logs are kept decentralized. It is difficult to check every log manually and to precisely extract typical records, which could help locate the root cause. The complexity of root causes may be as follows: a virtual network interface card (VNIC) is not ready, (e.g., network-daemon pod crash, etc.); a volume is not provisioned (e.g., storage outage or out of storage space, netapp-volume-provisioner-block crash, volume-controller crash, etc.); a storage device is not ready (e.g., post mount issue: storage-daemon pod crash, vault-agent is not running, vault server crash, etc.); cloud-init is not ready (e.g., compute-daemon pod crash, etc.); computedomain issue (e.g., Fabcon service crash, Libvirt crash, vault-agent is not running, vault server crash, etc.); image lost; etcd database; network connection issue; etc. These potential root causes may result in complex actions, such as: 1. Check if an Object virtual machine had been created; 2a: check if an Object VMReservation had been created; 2a1: check if an available node had been assigned to the virtual machine; 2a2: check if an Object Compute Node information is correct; 2b: check if an object VNic, network endpoint, a network interface had been created, network and endpoint had been provisioned, and network interface is ready for attaching; 2b1: check if a network interface has been attached to a virtual machine, a network service is running; 2c: check if an Object virtual disk, volume, storage device had been created, volume had been provisioned, storage device is ready for attaching; 2c1: check if a virtual disk has been attached to virtual machine, storage service is running; 2d: check if an Object compute domain had been created; 2d1: check if a virtual machine had been created on a hypervisor (HV) server, libvirt service is running; etc.

Conventionally, artificially finding the root cause and solving the problem after the VMI creation fails has a serious lag. There is a lack of a mechanism that can automatically read the logs generated by each pod in real time and extract key information to determine whether the current VMI creation process is normal. Some embodiments provide detection of the abnormal behavior during the resource schedule process in the early stage by checking the key log pattern and multiple wait times in each log source. In order to leverage the existing pattern recognition technical approach to identify the key log pattern, one or more embodiments provide a new format of the log pattern with consideration of the complex log object. Some embodiments provide a dimension reduction in the data processing and make it available for training. With reference to FIG. 1, a health checker 31 is generated by the result of the key log pattern. The health checker 31 may be applied to each log source and reports the alert in the runtime during the resource schedule process.

In some embodiments, on the control plane side (left side of FIG. 1), kubelet 10 sets a node status for a node 11. The node 11 listens for a node status change. The scheduler 14, with a checker agent, listens for a node status change and schedules the VMs 16. At reference 2, the scheduler 14 finds an available node and assigns it to the VM 16. A checker agent checks for status. VM-controller 17 listens for a VM to be created, with a checker agent, and communicates with the network 18 that is controlled with network-controller 19 with a checker agent. At the reference 1 after the VM 16, a user posts a request for a VM 16 creation, and the VM-controller 17 listens for an object VM to be created. At the reference 3, the VM-controller 17 creates an object VNIC, vdisk, and computedomain. The network 18 listens for a VM 16 to be scheduled and communicates with an HV server 20. At the reference 4, the network-controller 19 and NIC-related pods create and provision a networkendpoint and a networkinterface. The HV server 20 includes a network daemon with checker agent, a storage daemon (k8s daemen set (ds) per server) with an agent checker, a compute daemon (k8s ds per server) with a checker agent, and VM instance. A ds ensures that all eligible nodes run a copy of a pod. Storage 21 (e.g., Vdisk) communicates with a storage controller 23 (k8s pod) with an agent checker. The storage 21 listens for a VM 16 to be scheduled and communicates with the HV server 20. At the reference 5, the storage-controller and the disk-related pods create and provision volume, and storage device. At the reference 6 (within the HV server 20), the (daemon) compute-daemon works together with the network-daemon (or fabcon manager), and the storage daemon to launch a VM instance. Compute 22 (compute object) listens for the VM 16 to be runnable and communicates with the HV server 20.

In one or more embodiments, in the collect log portion 12 (center portion of FIG. 1), collects fluentd-logs and places them in storage. Fluentd is an open source data collector for unified logging layer and allows unification of data collection and consumption for a better use and understanding of data. The collected logs 24 are input to a pre-analysis process 25 portion that includes a data formatter 26 and a dimensionality reduction process 27. At the reference 1 of the pre-analysis process 25 portion, the collected log 24 is input into the data formatter 26 to flag/reorganize/format as the data according to the metric for the additional analysis process. At reference 2 of the pre-analysis process 25 portion, the formatted data is distributed into an n-dimensional space, and then through the dimensionality reduction process 27, where the data is processed via conventional pattern recognition processing. At reference 3 after the pre-analysis process 25 portion, the present technology uses a conventional approach to extract the key patterns to separate normal or abnormal status. At reference 4, the pattern extraction process 28 provides for extraction of the key patterns that is generated via the previous analysis from reference 3 to result in patterns 29. In the post-analysis process 30 portion, at reference 5, the key patterns 29 are input into a threshold formatter to identify the threshold for a health check (by the health checker 31). At reference 6, following the threshold, the checker formatter starts to form the health checker 31. At reference 7, the health checker 31 for each component is generated. At reference 8, the health checkers 31 are applied to each component, and then they check/report the status during runtime.

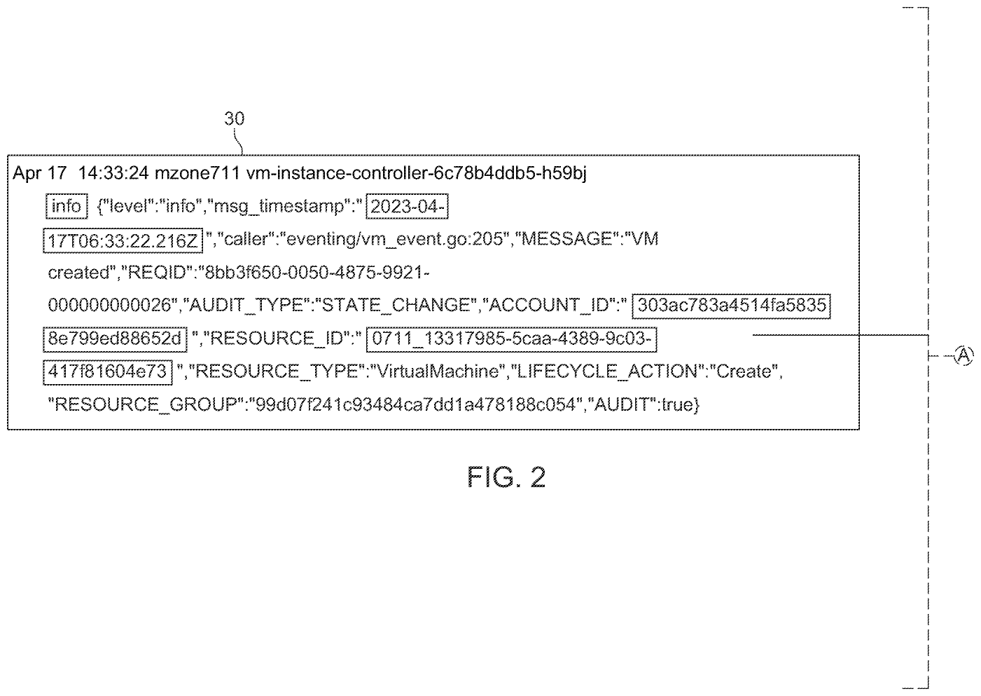

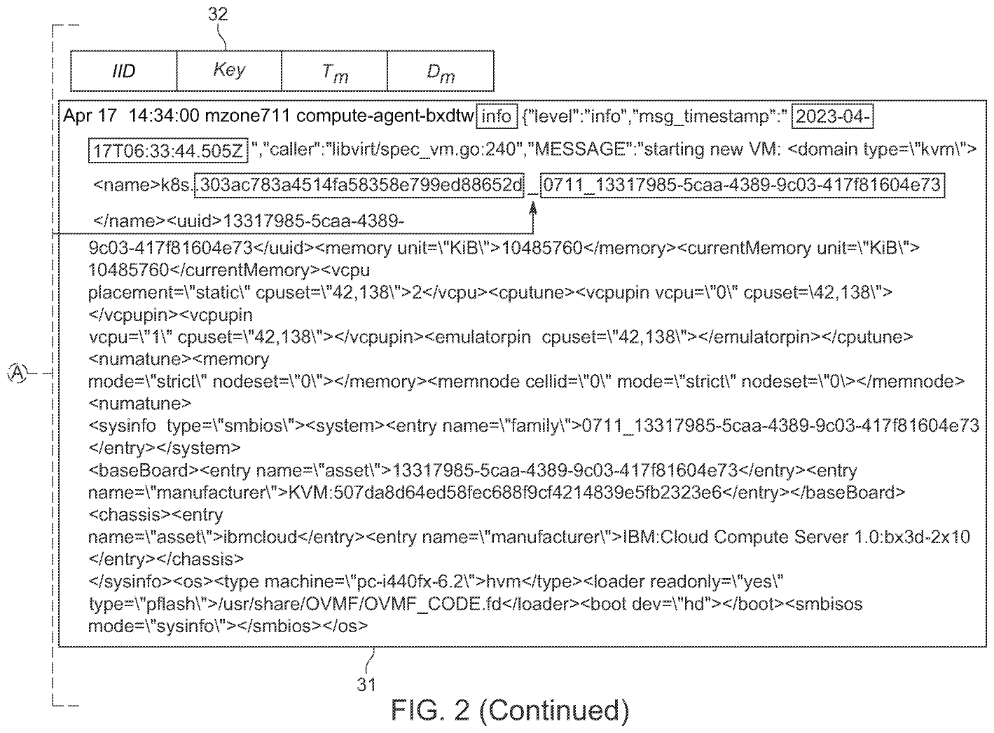

FIG. 2 illustrates a representation of formatting 32 for each history log, according to some embodiments. The pattern requirement for one or more embodiments are that they be independent and measurable. As shown, two example logs 33/34 follow the formatting 32. The arrow ends show the instance identification (IID). In some embodiments, the format metric is as follows: let tₛ be the start time for a unique request that is identified by IID in a certain log source. Let tm be the time of each log occur. Then for each log, there will be Tₘ=tₘ−tₛ. Let to be the initial time of a unique request. Then for each log: Dₘ=tₘ−tᵢ. For the content of each log, there will be key information (let it be Key) represented for it that is obtained from a log analysis process, which is a process of reviewing computer-generated event logs to proactively identify bugs, security threats or other risks.

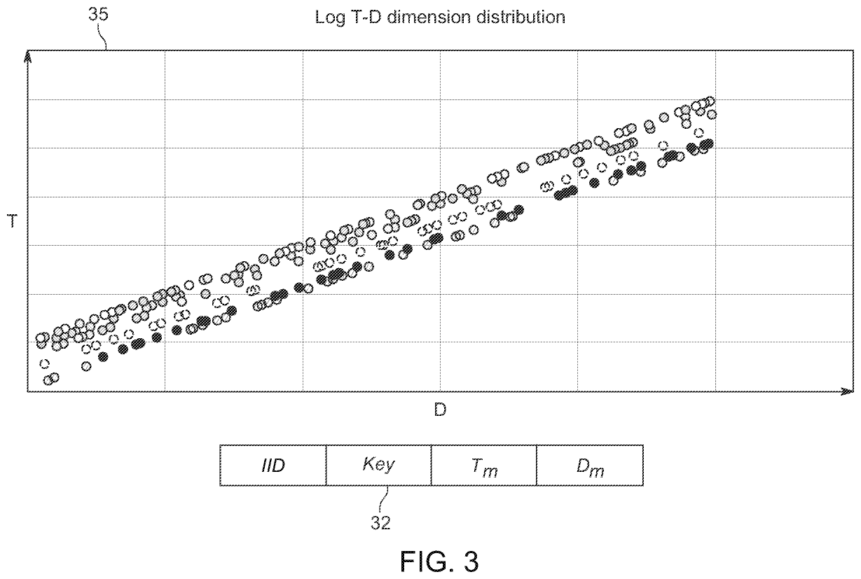

FIG. 3 illustrates a graph 35 of Log T-D dimension distribution, according to some embodiments. In order for the present technology to prepare for training, let k represent the Key, and distribute them into the T-D dimension. In one or more embodiments, there is (for a certain data set) a distribution as depicted in graph 35. Then for each data source, there is an m dimensions data considering the data sets. Here m refers to the number of the messages in the log. From different data sets, there is a deviation of the same message. In some embodiments, the goal is to find the message with good data characteristics, which are: a representative sample (for a certain interval, it stays on the fixed middle position), less deviation (for the certain message in the different training set, there will be less deviation). In one or more embodiments, the training set is labeled as follows. For the existing data sets, if the present technology obtains the successful/acceptable results, the system marks it (sets a bit, sets a flag, etc.) as the normal set. If the present technology obtains the failed/unacceptable results, the system marks it as the failed set.

In some embodiments, for data supplement, besides the existing history data, the data set from a large number of experiments exist, which is marked following the same rule as for labels as described above. In one or more embodiments, for the dimension reduction processing, the process is performed with the same labeled data sets. For a first dimension reduction process, the dimension reduced rule is defined as follows. Set two hyper-parameters rₘ and rₖ, for which:

$${r}_{m} \geq {max}_{( x , y ∈ k )} ‖ {T}_{x} - {T}_{y} ‖$$

$$and$$

$${r}_{k} \geq {max}_{( x , y ∈ D )} ‖ {T}_{x} - {T}_{y} ‖ ( D belongs to a single training dataset ) .$$

Then the first process adjusts rₖ; and for each training set, there is a subset: D₁, D₂, . . . , Dₙ. The initial value for rₖ can be large so as to only generate one subset. The second process provides iterative dimension reduction, as follows, to identify the core of each subset. In one or more embodiments, in a subset Dᵢ, the second process finds the mean of the k (k∈Dᵢ). The second process then finds kᵢ∈Dᵢ, S.T. min rₘ where

$${r}_{m} \geq {max}_{( x , y ∈ {k}_{i} )} ‖ {T}_{x} - {T}_{y} ‖ .$$

The second process continues by checking the distance of kᵢ and the mean of the k (k∈Dᵢ). Further, the second process sets a threshold for distance d, if

$$d \geq ‖ k - {k}_{i} ‖ ,$$

then the second process reduces the rₖ and re-iterates the first process.

In one or more embodiments, the third process provides consideration of convergence. When there is no adjustment for d that fulfills the dimension reduction rule of the second process, the processing stops. Considering the analytics resource, if there is still room for capacity, the third process increases the threshold and reiterates processing for the first, second and third process. Finally, the processing provides reduced dimensions.

In some embodiments, the present technology uses conventional linear classifier processing to perform the training. In one example, let G(x)=ω^{T}(x)+ω₀ (model function) and input the training datasets in the model with different flags (input for training). When the flag is normal, let G(x)>0; and when the flag is abnormal, let G(x)<0. Then, the decision surface is y(x)=0 (decision surface). The exponent function may be used as the loss function:

$$L ( Y \vert G ( x ) ) = exp ( - y G ( x ) ) .$$

After training, the ω is identified to have the minimum loss function, and uses the following rules to identify the key pattern. First, keep some patterns with max ∥ω∥. If there is not a selected pattern for a certain log source Sᵢ, check if there is non-zero value of ω for it. If yes, keep it. If no, ignore it. Mark all the selected patterns for normal as set P, and the failed selected patterns as set F with the member pᵢ. In some embodiments, for the fault threshold, using rₘ for each pᵢ as the value threshold, set

$${r}_{d} = {max}_{( x ∈ {S}_{i} ⋂ P )} ‖ {D}_{x} ‖ .$$

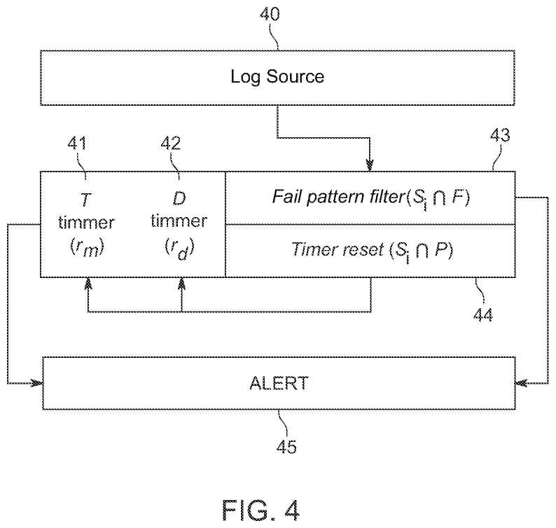

FIG. 4 illustrates a flow diagram for a health checker 31 (FIG. 1), according to some embodiments. In one or more embodiments, there are three (3) parts of the health checker 31 for each log source 40: a failed pattern filter which includes all the failed log patterns in set Sᵢ∩F (fail pattern filter 43); two (2) timers are reset with the normal pattern Sᵢ∩P (timer reset 44); and a timer with threshold as rₘ 41 and r_{d} 42. In some embodiments, for the health checking process, the runtime log is input into the fail pattern filter to check if it is passed. If the runtime log passed, the present technology provides a timer reset check. If the runtime log does not pass, which means a fail pattern occurred, the present technology reports an alert 45. The timer reset 44 will check if a next normal pattern is reached: if yes, the present technology resets the two timers. Otherwise, the present technology: if no, the present technology passes this portion and continues. In some embodiments, the two timers check if they have reached the threshold rₘ and r_{d}. If rₘ is reached, it means that the operation wait time is abnormal. If r_{d} is reached, it means that the total wait time is abnormal. Both times report the alert 45.

In one or more embodiments, the present technology may be applied to a private cloud, a public cloud, and hybrid cloud platforms for assisting users to check and predict the success of VMI creation. Finding the root cause of VMI creation failure is a difficult and complicated matter. Almost all cloud platforms need such a mechanism to handle a VMI schedule and heath check.

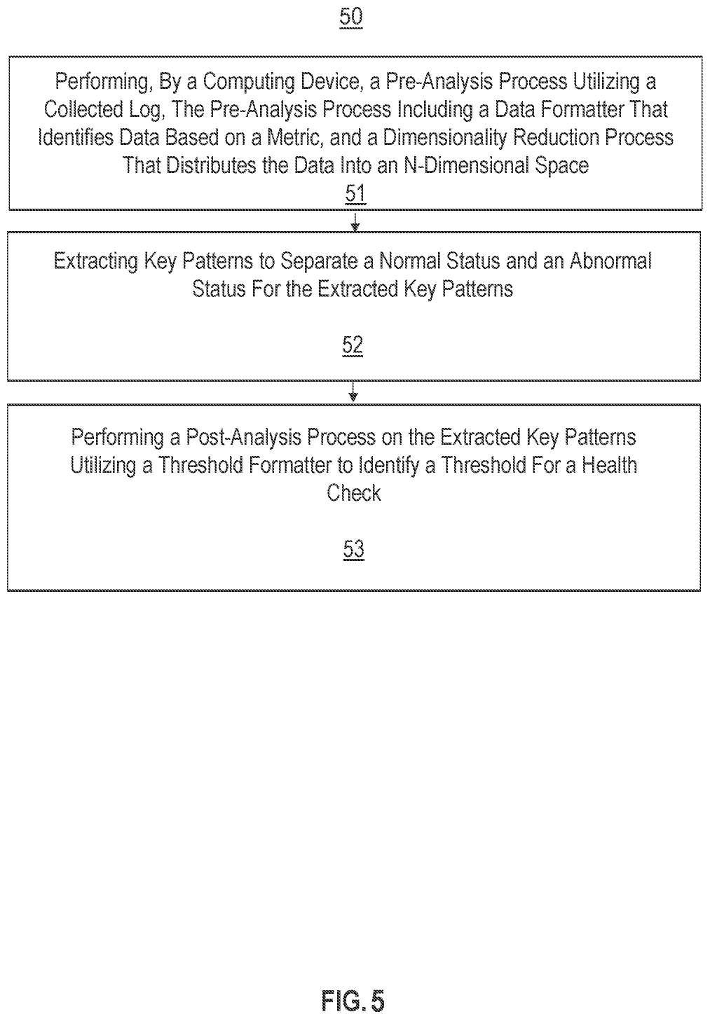

FIG. 5 illustrates a process 50 for intelligently detecting resource schedules for computing systems, according to some embodiments. In one or more embodiments, in block 51, process 50 performs, using a computing device, a pre-analysis process utilizing a collected log from multiple sources. The pre-analysis process includes a data formatter that identifies data based on a metric, and a dimensionality reduction process that distributes the data into an n-dimensional space. In block 52, process 50 extracts, using the computing device, key patterns to separate a normal status and an abnormal status for the extracted key patterns. In block 53, process 50 performs, using the computing device, a post-analysis process on the extracted key patterns utilizing a threshold formatter to identify a threshold for a health check.

Some embodiments provide collection of scattered data, extraction of key patterns via data formatting and data dimensionality reduction processing. Extracted patterns are used to separate the normal and abnormal status during VMI creation. The patterns are used as the input into a threshold formatter to identify the threshold for health check processes. With the health check processes, some embodiments improve the possibility to discover an exception in the VMI creation process and to predict whether the VMI can be successfully created in advance.

Thus, process 50 achieves solving the problems that lead to the failure of VMI creation in cloud environments in a timely manner using multiple health check processes. By using collection of scattered data, extraction of key patterns via data formatting, data dimensionality reduction processing and multiple health check processes, process 50 improves the possibility to discover an exception in the VMI creation process and to predict whether the VMI can be successfully created in advance.

In one or more embodiments, process 50 may include the feature that the health check is utilized for discovering an exception in a VMI creation process.

In some embodiments, process 50 may further include the feature that the health check is utilized to predict whether a VMI can be successfully created in advance.

In one or more embodiments, process 50 may further include the feature that a runtime log is provided as input to a failed pattern filter that determines whether the runtime log passes the failed pattern filter.

In some embodiments, process 50 may include the feature of upon the runtime pattern filter passing the runtime log, a timer reset check determines whether a next normal pattern is reached based on a threshold.

In one or more embodiments, process 50 may further include the feature that a health check agent is generated for multiple system components for the pre-analysis process and the post-analysis process.

In some embodiments, process 50 may additionally include the feature of the health check is applied to a runtime log in each of the multiple sources.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

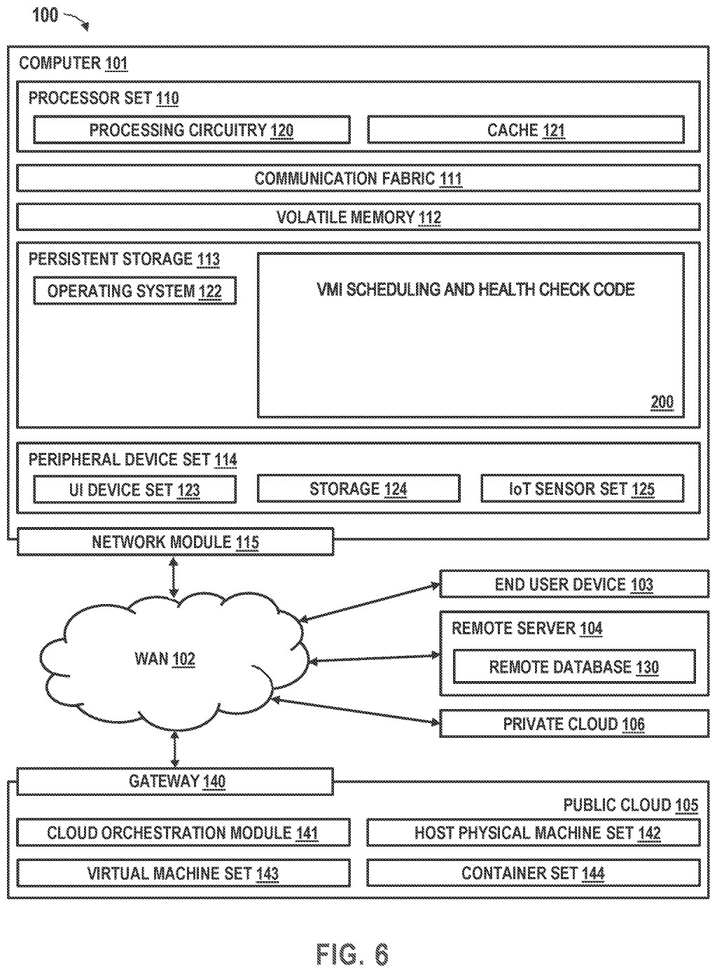

FIG. 6 illustrates an example computing environment 100 utilized by some embodiments. Computing environment 100 contains an example of an environment for the execution of at least some of VMI scheduling and health check computer code 200 involved in performing the inventive methods. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

What is claimed is:

1. A method comprising:
performing, by a computing device, a pre-analysis process utilizing a collected log from multiple sources, the pre-analysis process including a data formatter that identifies data based on a metric, and a dimensionality reduction process that distributes the data into an n-dimensional space;
extracting, by the computing device, key patterns from the data to separate a normal status and an abnormal status for the extracted key patterns; and
performing, by the computing device, a post-analysis process on the extracted key patterns utilizing a threshold formatter to identify a threshold for a health check.

2. The method of claim 1, wherein the health check is utilized for discovering an exception in a virtual machine instance (VMI) creation process.

3. The method of claim 2, wherein the health check is utilized to predict whether a VMI can be successfully created in advance.

4. The method of claim 3, wherein a runtime log is provided as input to a failed pattern filter that determines whether the runtime log passes the failed pattern filter.

5. The method of claim 4, wherein upon the runtime pattern filter passing the runtime log, a timer reset check determines whether a next normal pattern is reached based on a second threshold.

6. The method of claim 1, wherein a health check agent is generated for a plurality of system components for the pre-analysis process and the post-analysis process.

7. The method of claim 1, wherein the health check is applied to a runtime log in each of the multiple sources.

8. A computer program product for detecting a computing system resource schedule, the computer program product comprising a computer readable storage medium having program instructions embodied therewith, the program instructions executable by a processor to cause the processor to:
perform, by the processor, a pre-analysis process utilizing a collected log from multiple sources, the pre-analysis process including a data formatter that identifies data based on a metric, and a dimensionality reduction process that distributes the data into an n-dimensional space;
extract, by the processor, key patterns from the data to separate a normal status and an abnormal status for the extracted key patterns; and
perform, by the processor, a post-analysis process on the extracted key patterns utilizing a threshold formatter to identify a threshold for a health check.

9. The computer program product of claim 8, wherein the health check is utilized for discovering an exception in a virtual machine instance (VMI) creation process.

10. The computer program product of claim 9, wherein the health check is utilized to predict whether a VMI can be successfully created in advance.

11. The computer program product of claim 10, wherein a runtime log is provided as input to a failed pattern filter that determines whether the runtime log passes the failed pattern filter.

12. The computer program product of claim 11, wherein upon the runtime pattern filter passing the runtime log, a timer reset check determines whether a next normal pattern is reached based on a second threshold.

13. The computer program product of claim 8, wherein a health check agent is generated for a plurality of system components for the pre-analysis process and the post-analysis process.

14. The computer program product of claim 8, wherein the health check is applied to a runtime log in each of the multiple sources.

15. A system comprising:
a memory configured to store instructions; and
a processor configured to execute the instructions to:
perform a pre-analysis process utilizing a collected log from multiple sources, the pre-analysis process including a data formatter that identifies data based on a metric, and a dimensionality reduction process that distributes the data into an n-dimensional space;
extract key patterns from the data to separate a normal status and an abnormal status for the extracted key patterns; and
perform a post-analysis process on the extracted key patterns utilizing a threshold formatter to identify a threshold for a health check.

16. The system of claim 15, wherein the health check is utilized for discovering an exception in a virtual machine instance (VMI) creation process.

17. The system of claim 16, wherein the health check is utilized to predict whether a VMI can be successfully created in advance.

18. The system of claim 17, wherein a runtime log is provided as input to a failed pattern filter that determines whether the runtime log passes the failed pattern filter.

19. The system of claim 18, wherein upon the runtime pattern filter passing the runtime log, a timer reset check determines whether a next normal pattern is reached based on a second threshold.

20. The system of claim 15, wherein:
a health check agent is generated for a plurality of system components for the pre-analysis process and the post-analysis process; and
the health check is applied to a runtime log in each of the multiple sources.
